(19) United States
(12) Patent Application Publication
(10) Pub. No.: US 2019/0266096 A1
(43) Pub. Date: Aug. 29, 2019

(54) DATA STORAGE DEVICE, METHOD OF OPERATING THE SAME, AND STORAGE SYSTEM HAVING THE SAME

(71) Applicant: SK hynix Inc., Gyeonggi-do (KR)

(72) Inventors: Joo Young LEE, Seoul (KR); Hoe Seung JUNG, Seoul (KR); Sung Kwan HONG, Seoul (KR)

(21) Appl. No.: 16/109,207

(22) Filed: Aug. 22, 2018

(30) Foreign Application Priority Data
Feb. 27, 2018 (KR) 10-2018-0023698

(51) Int. Cl. G06F 12/0875; G06F 3/06

(52) U.S. Cl. CPC G06F 12/0875; G06F 3/0613; G06F 3/0631; G06F 3/0656; G06F 2212/604; G06F 2212/1021; G06F 2212/2022; G06F 2212/45; G06F 3/0679

(57) ABSTRACT

A data storage device may include: a storage unit; a controller configured to write data to the storage unit or read data from the storage unit; and a plurality of buffer memories. The controller may include a write control unit configured to allocate a buffer memory for temporarily storing data to be written in different manners depending on the kind of data to be written to the storage unit based on a write-related command provided from a host device.

### CROSS-REFERENCE TO RELATED APPLICATION

The present application claims priority under 35 U.S.C. § 119(a) to Korean application number 10-2018-0023698, filed on Feb. 27, 2018, in the Korean Intellectual Property Office, which is incorporated herein by reference in its entirety.

### BACKGROUND

### 1. Technical Field

Various embodiments generally relate to a semiconductor integrated device. Particularly, the embodiments relate to a data storage device, a method of operating the data storage device, and a storage system having the data storage device.

### 2. Related Art

A storage device is coupled with a host device and configured to perform a data access operation in response to a request of the host. The storage device may use various storage mediums to store data. Particularly, in the case of mobile information devices, the capacities of the storage mediums employed therein have gradually increased so as to provide various functions based on multimedia data.

There is a growing demand for a storage medium using a flash memory due to its advantages of supporting high capacity, being nonvolatile, having low production cost and power consumption, and having high data processing speed.

The flash memory may be embodied by a solid state drive (hereinafter, referred to as “SDD”) type substituting for a hard disk, an embedded type capable of being used as an embedded memory, a mobile type, etc. Flash memory may be used in various electronic devices.

With the development of electronic devices, there is a demand for the storage medium to meet requirements of higher capacity, higher integration, miniaturization, higher performance, and higher speed. Particularly, in the case of a storage medium used for processing massive quantities of data, data processing speed acts as a significant factor in the performance of the storage medium.

### SUMMARY

Various embodiments are directed to a data storage device having an enhanced data processing speed, a method of operating the data storage device, and a storage system having the data storage device.

In an embodiment, a data storage device may comprising a storage; a controller configured to write data to the storage or read data from the storage; and a plurality of buffer memories, wherein the controller comprises a write control component configured to allocate a buffer memory, of the plurality of buffer memories, for temporarily storing data to be written in different ways depending on a kind of the data to be written to the storage based on a write-related command received from a host device.

In an embodiment, a data storage device may include comprising a storage, a plurality of buffer memories, and a controller configured to control data exchange with respect to the storage, wherein the controller comprises: a command parser configured to parse a write-related command received from a host device; a write information generator configured to allocate a buffer memory, of the plurality of buffer memories, for temporarily storing data to be written in different ways depending on a kind of the data to be written to the storage based on a result of a parsing operation of the command parser, and generate write information needed to write the data; a first data writer configured to write data to the allocated buffer memory based on the write information; and a second data writer configured to write the data temporarily stored in the allocated buffer memory to the storage based on the write information.

In an embodiment, a method of operating a data storage device including a storage, a plurality of buffer memories, and a controller configured to control data exchange with respect to the storage, the method comprising: parsing, by the controller, a write-related command received from a host device; allocating a buffer memory, of the plurality of buffer memories, for temporarily storing data to be written in different ways depending on a kind of the data to be written to the storage based on a result of the parsing, and generating write information to write the data; writing data, in a temporary write operation, to the allocated buffer memory based on the write information; and writing the data temporarily stored in the allocated buffer memory, in a main write operation, to the storage based on the write information.

In an embodiment, a storage system may include: a host device; and a data storage device including a storage, a plurality of buffer memories, and a controller configured to write data to the storage or read data from the storage, wherein the controller comprises a write control component configured to allocate a buffer memory, of the plurality of buffer memories, for temporarily storing data to be written in different ways depending on a kind of the data to be written to the storage based on a write-related command received from the host device.

In an embodiment, a memory system may include: a memory device configured to store data; first and second buffer memories configured to buffer data to be stored into the memory device; and a controller configured to: buffer, in response to a first write command, first data in the first buffer memory; and buffer, in response to a second write command, second data in the second buffer memory, and generate third data from the second data, the third data being appropriate for storage into the memory device; transmit a write completion message; and control the memory device to store the first and third data therein after transmit the write completion message.

### BRIEF DESCRIPTION OF THE DRAWINGS

FIG. 1 is a diagram illustrating a configuration of a data storage device in accordance with an embodiment.

FIG. 2 is a diagram illustrating configurations of a controller and a buffer memory array in accordance with an embodiment.

FIG. 3 is a diagram illustrating a configuration of a write control component in accordance with an embodiment.

FIG. 4 is a flowchart illustrating a method of operating the data storage device in accordance with an embodiment.

FIG. 5 is a diagram illustrating a data processing system including a solid state drive (SSD) in accordance with an embodiment.

FIG. 6 is a diagram illustrating a data processing system including a memory system in accordance with an embodiment.

FIG. 7 is a diagram illustrating a data processing system including a memory system in accordance with an embodiment.

FIG. 8 is a diagram illustrating a network system including a memory system in accordance with an embodiment.

FIG. 9 is a block diagram illustrating a nonvolatile memory device in a memory system in accordance with an embodiment.

### DETAILED DESCRIPTION

A data storage device, a method of operating the data storage device, and a storage system having the data storage device will be described below with reference to the accompanying drawings through various embodiments. We note, however, that the present teaching may be embodied in different forms and variations, and should not be construed as being limited to the embodiments set forth herein. Rather, the described embodiments are provided so that this disclosure will be thorough and complete, and will fully convey the present teaching to those skilled in the art to which this technic pertains. Throughout the disclosure, like reference numerals refer to like parts throughout the various figures and embodiments of the present teaching.

It is noted that, throughout the specification, reference to “an embodiment” or the like is not necessarily to only one embodiment, and different references to “an embodiment” or the like are not necessarily to the same embodiment(s).

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present teaching.

As used herein, singular forms may include the plural forms as well and vice versa, unless the context clearly indicates otherwise.

Hereinafter, the various embodiments of the present teaching will be described in detail with reference to the attached drawings.

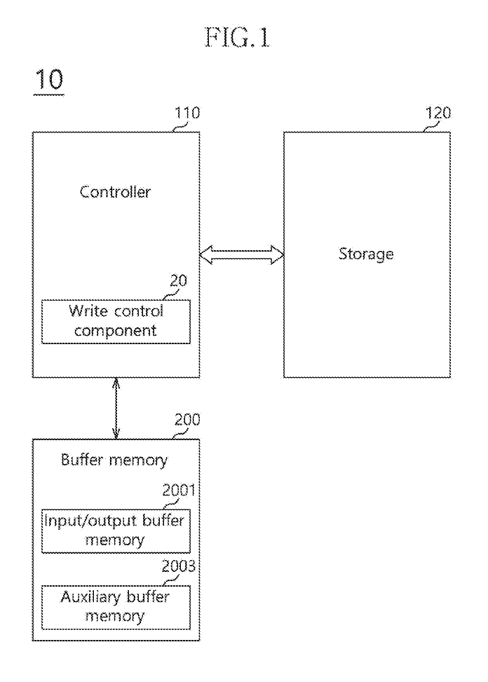

FIG. 1 is a diagram illustrating a configuration of a data storage device 10 in accordance with an embodiment.

Referring to FIG. 1, the data storage device 10 may include a controller 110 and a storage 120. In addition, a buffer memory array 200 may be provided within or external to the controller 110.

The controller 110 may control the storage 120 in response to a request of a host device, which may be a host processor. For example, the controller 110 may enable data to be programmed to the storage 120 in response to a program (write) request of the host device. Furthermore, the controller 110 may provide the data stored in the storage 120 to the host device in response to a read request of the host device.

The storage 120 may store data or output stored data under control of the controller 110. The storage 120 may be formed of a volatile or nonvolatile memory device. In an embodiment, the storage 120 may be embodied using a memory element selected from among various nonvolatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-MRAM). The storage 120 may include a plurality of dies, a plurality of chips, or a plurality of packages. In addition, the storage 120 may be formed of single-level cells each capable of storing one bit of data, or multi-level cells each capable of storing a plurality of bits of data.

The buffer memory array 200 functions as a space capable of temporarily storing data when the data storage device 10 performs a series of operations, e.g., including an operation of writing or reading data, in conjunction with the host device.

The controller 110 may include a write control component 20. The write control component 20 may be configured to allocate a buffer memory for temporary data storage in different ways depending on the kind of data to be written when the data storage device 10 performs a write operation in response to a host command.

In an embodiment, the buffer memory array 200 may include an input/output buffer memory 2001 and an auxiliary buffer memory 2003. When the host device issues a normal write command, the data storage device 10 may temporarily store, to the input/output buffer memory 2001, data to be written to the storage 120. On the other hand, when the host device issues a command instructing a write operation, other than the normal write command, the data storage device 10 may temporarily store, to the auxiliary buffer memory 2003, data to be written.

In an embodiment, the command instructing the write operation, other than the normal write command, may include a replay protected memory block (RPMB) write command, and a unmap command.

During a write operation according to the RPMB write command, there is a need for the controller 110 or the write control component 20 to perform an operation of processing data to be written. In an embodiment, the operation of processing data may be an operation of synchronizing the units of data to be processed during the write operation according to the RPMB write command.

The unit of data of the normal write operation may have a first size (e.g., 4K bytes). The unit of data to be transmitted from the host device during the RPMB write operation may have a second size (e.g., 256 bytes) less than the first size. Therefore, the controller 110 or the write control component 20 may modify the size of RPMB write data so that the RPMB write operation may be synchronized with a normal write operation.

During a write operation instructed by the unmap command, dummy data having the same level may be written to a region in which map data has been written, rather than meaningful data. The dummy data may be data generated from the controller 110 or the write control component 20 rather than being provided from the host device.

Hence, during the RPMB write operation or the unmap operation, data provided from the host device may be processed through a self-processing procedure of the controller 110 before being stored to the storage 120, rather than the data being directly written to the storage 120. In other words, data may not be provided from the host device, or there is no need for the data provided from the host device to be retained in a buffer memory region. Therefore, in the case of the command instructing the write operation, other than the normal write command, the auxiliary buffer memory 2003 may be allocated as a temporary storage region so that efficiency in the use of the input/output buffer memory 2001 may be enhanced.

Under control of the write control component 20, the input/output buffer memory 2001 may be managed as a space for temporarily storing only user data. As such, sufficient space for temporarily storing user data may be secured. In response to the normal write command from the host device, user data may be immediately stored to the input/output buffer memory 2001, and a response signal may be transmitted to the host device. In this way, a high-speed operation may be secured.

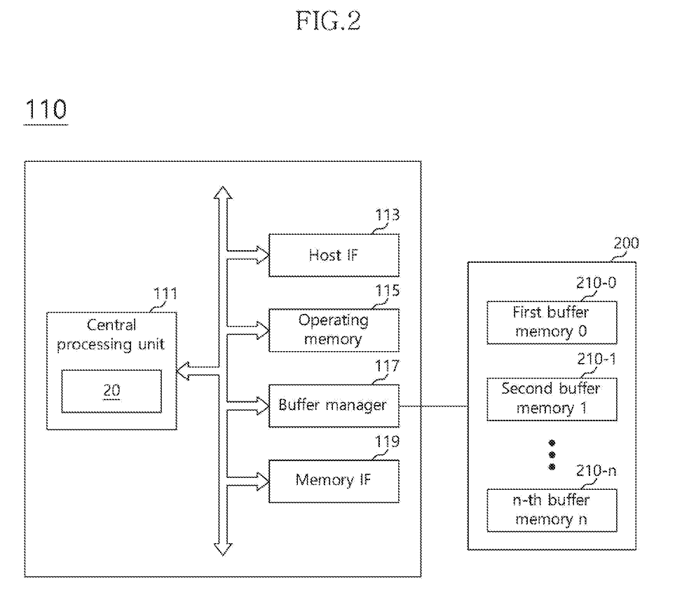

FIG. 2 is a diagram illustrating configurations of the controller 110 and the buffer memory array 200 in accordance with an embodiment.

Referring to FIG. 2, the controller 110 may include a central processing unit (e.g., a CPU) 111, a host interface 113, an operating memory 115, a buffer manager 117, and a memory interface 119.

The buffer memory array 200 may include first to n-th buffer memories 210-0 to 210-n. The plurality of buffer memories 210-0 to 210-n may include at least one input/output buffer memory 2001 and at least one auxiliary buffer memory 2003.

The central processing unit 111 may transmit various control information needed for a data read or write operation to the host interface 113, the operating memory 115, the buffer manager 117, and the memory interface 119. In an embodiment, the central processing device 111 may operate according to firmware provided for various operations of the data storage device 10. In an embodiment, the central processing unit 111 may implement the function of a flash translation layer (FTL) for performing a garbage collection operation, an address mapping operation, a wear leveling operation, and the like for managing the storage 120. As an embodiment, the central processing unit 111 may detect error in data read from the storage 120 and correct the error.

The host interface 113 may provide a communication channel configured to receive a command and a clock signal from the host device (e.g., host processor) and control input or output of data under control of the central processing unit 111. Particularly, the host interface 113 may provide physical connection between the host device and the data storage device 10. Furthermore, the host interface 113 may provide an interface with the data storage device 10 in conformance with a bus format of the host device. The bus format of the host device may include at least one of standard interface protocols such as secure digital, universal serial bus (USB), multi-media card (MMC), embedded MMC (eMMC), a personal computer memory card international association (PCMCIA), parallel advanced technology attachment (PATH), serial advanced technology attachment (SATA), small computer system interface (SCSI), serial attached SCSI (SAS), peripheral component interconnection (PCI), PCI express (PCI-E), and universal flash storage (UFS).

The operating memory 115 may store program codes (for example, store code data stored in firmware or software and to be used by program codes) needed for the operation of the controller 110.

The buffer manager 117 may temporarily store, to the buffer memory array 200, data to be transmitted between the host device and the storage 120 during a program operation or a read operation.

The buffer memory array 200 may include a plurality of buffer memories 210-0 to 210-n including the input/output buffer memory 2001. In an embodiment, each of the plurality of buffer memories 210-0 to 210-n may be formed of a volatile or nonvolatile memory. In an embodiment, the plurality of buffer memories 210-0 to 210-n may include an SRAM and/or a DRAM, but are not limited to those configurations.

Each of the buffer memories 210-0 to 210-n may be divided into a plurality of regions, for example, on a basis of a plurality of sectors, volumes, or banks.

The buffer manager 117 may manage a use state of each of the buffer memories 210-0 to 210-n, or more specifically, a use state of the plurality of regions of each of the buffer memories 210-0 to 210-n.

Although FIG. 2 illustrates an example in which the buffer memory array 200 is disposed externally to the controller 110, the buffer memory array 200 may be provided in the controller 110 and managed by the buffer manager 117.

The memory interface 119 may provide a communication channel for signal exchange between the controller 110 and the storage 120. The memory interface 119 may write data temporarily stored in the buffer memory array 200 to the storage 120 under control of the central processing unit 111. In addition, the memory interface 119 may transmit data read from the storage 120 to the buffer memory array 200 to temporarily store the data.

When the host command is a normal write command, the write control component 20 may temporarily store user data to the input/output buffer memory 2001 of the buffer memory array 200. When the host command is a command instructing a write operation, other than the normal write command, the write control component 20 may temporarily store data to be written, to the auxiliary buffer memory 2003 rather than to the input/output buffer memory 2001.

In an embodiment, the write operation in response to a request of the host device may be performed through two steps. A first process may include temporarily storing, to the buffer memory array 200, data to be written, and be referred to as a temporary write process. A second process may include storing the data temporarily stored in the buffer memory array 200 to the storage 120 through the buffer manager 117 and the memory interface 119, and be referred to as a main write process.

When the temporary write process is completed during the write operation, the write controller 20 may transmit a response signal, notifying that the operation of processing the write command has been completed, to the host device through the host interface 113. The main write process that has not yet been completed may be performed at an internally-determined point in time, taking into account working conditions of the data storage device 10.

During the main write process, the central processing unit 111 may implement the FTL function to map a logical address provided from the host device to a physical address. Thereafter, the central processing unit 111 may write the data to a region corresponding to the mapped physical address.

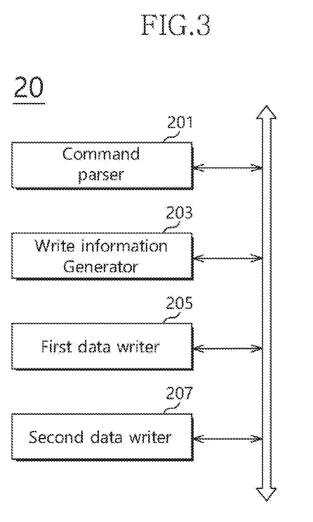

FIG. 3 is a diagram illustrating a configuration of the write controller 20 in accordance with an embodiment.

Referring to FIG. 3, the write control component 20 may include a command parser 201, a write information generator 203, a first data writer 205, and a second data writer 207.

The command parser 201 may parse a write-related command, e.g., a normal write command or a write operating instructing command, provided from the host device. The write operation instructing command may include a replay protected memory block (RPM B) write command, and a unmap command.

The write information generator 203 may generate write information, which is meta information needed for a write operation, based on a result of a parsing operation of the command parser 201.

For example, the write information may include the following.

TABLE 1

| | |
|---|---|
| 1 | Start address of logical block address at which the |
| | host device desires to write data |
| 2 | Length of data desired to be written |
| 3 | Actual length of data written in the storage 120 |
| 4 | Identifier of the region in the buffer memory array |
| | 200 to which data is to be temporarily stored |
| 5 | Data location in the buffer memory array 200 |
| 6 | Flag indicating the kind of command related to data |
| 7 | RPMB address at which data is to be written in the |
| | storage 120 |

Item 3 (the actual length of data written in the storage 120) in [Table 1] may be updated after an address mapping operation and a write operation of the write control component 20. Furthermore, item 7 (the RPMB address at which data is to be written in the storage 120) may be data to be generated only in the case of the RPMB write command.

The write information generator 203 may perform a buffer memory scheduling operation in conjunction with the buffer manager 117. For example, one among the buffer memories 210-0 to 201-n to which data to be written to the storage 120 is to be temporarily stored may be allocated, and the identifier of the allocated buffer memory, of buffer memories 210-0 to 210-n, may be included in the write information. In addition, a temporary storage location of write data in the allocated buffer memory may be scheduled, and this may be included in the write information.

In an embodiment, the write information generator 203 may be configured to allocate a buffer memory for temporary data storage in different ways depending on the kind of data to be written or the kind of command of the host device.

In an embodiment, when the command of the host device is a normal write command, the write information generator 203 may temporarily store, to the input/output buffer memory 2001, data to be written. On the other hand, when the command of the host device is a command instructing a write operation, other than the normal write command, the write information generator 203 may temporarily store, to the auxiliary buffer memory 2003, data to be written.

The first data writer 205 may perform a temporary write operation based on the write information generated from the write information generator 203. In other words, the first data writer 205 may store the write data to a predetermined location of the buffer memory (one of 210-0 to 210-n) allocated by the write information generator 203. If the temporary write operation is completed, the first data writer 205 may transmit, to the host device through the host interface 113, a response signal notifying that the operation of processing the write command has been completed.

The second data writer 207 may perform a main write operation based on the write information generated by the write information generator 203.

In other words, the second data writer 207 may map a start address of a logical block address at which the host device desires to write data to a physical address, and write, starting from a region corresponding to the mapped physical address, write data having a length desired to be written in the storage 120.

If the data temporarily stored in the buffer memory array 200 is stored to the storage 120 in the above-mentioned manner, the second data writer 207 may update the write information according to information indicating the actual length of data written in the storage 120.

The main write process may be internally processed depending on working conditions of the data storage device 10.

As such, under control of the write control component 20, the input/output buffer memory 2001 of the plurality of buffer memories 210-0 to 210-n may be used as the temporary storage space for only user data. Therefore, sufficient space for temporarily storing user data may be secured. Furthermore, in response to the normal write command from the host device, the user data may be immediately stored to the input/output buffer memory 2001, and the response signal may be transmitted to the host device, whereby a high-speed operation may be secured.

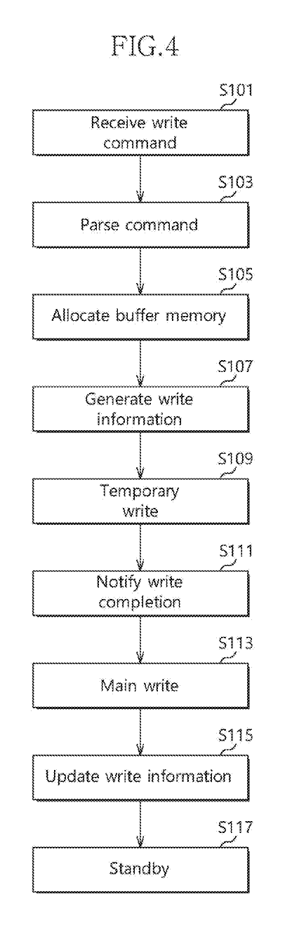

FIG. 4 is a flowchart illustrating a method of operating the data storage device 10 in accordance with an embodiment.

As a command is transmitted from the host device to the data storage device 10 at step S101, the write control component 20 may parse the command and generate write information at step S103.

The write control component 20 may allocate one among the buffer memories 210-0 to 210-n to which data to be written is to be temporarily stored, based on the kind of command transmitted from the host, or the kind of data to be written to the storage 120 at step S105.

In an embodiment, in the case where the command of the host device is a normal write command, or data to be written is user data, the write control component 20 may allocate the input/output buffer memory 2001 as the temporary storage region.

In an embodiment, in the case where the command of the host device is a command instructing a write operation, other than the normal write command, or the data to be written is RPMB data or dummy data for unmapping, the write control component 20 may allocate the auxiliary buffer memory 2003 as the temporary storage region.

During a write operation according to the RPMB write command, the data to be written should be processed to be synchronized with the normal write operation by the controller 110 or the write control component 20. In an embodiment, the unit of data to be processed during the normal write operation may have a first size (e.g., 4K bytes). The unit of data to be transmitted from the host device during the RPMB write operation may have a second size (e.g., 256 bytes) less than the first size. Therefore, the controller 110 or the write control component 20 may modify the size of RPMB write data so that the RPMB write operation may be synchronized with the normal write operation.

In an embodiment, for the RPMB write operation, some of the buffer memories 210-0 to 210-n may be allocated as an RPMB-exclusive temporary buffer. During the RPMB write operation, data to be written may be transmitted from the host device on a second size basis and stored to the RPMB-exclusive temporary buffer. The controller 110 or the write control component 20 may modify the data stored in the RPMB-exclusive temporary buffer to correspond to the first size and then transmit (copy) the data to the allocated auxiliary buffer memory 2003.

During a write operation according to the unmap command, dummy data having the same level may be written to a region in which map data has been written, rather than meaningful data. The dummy data may be data generated from the controller 110 or the write control component 20 rather than being provided from the host device. Therefore, during the RPMB write operation or the unmap operation, the data to be written may be processed through a self-processing procedure of the controller 110 before the data is written into the storage 120. Hence, data may not be provided from the host device, or there is no need for the data provided from the host device to be retained intact in the buffer memory region. Therefore, in the case of the command instructing the write operation, other than the normal write command, the auxiliary buffer memory 2003 may be allocated as the temporary storage region so that efficiency in the use of the input/output buffer memory 2001 may be enhanced.

As the buffer memory to which the data to be written is to be temporarily stored is allocated among the buffer memories 210-0 to 210-n, write information is generated at step S107. In an embodiment, the write information may include a start address of a logical block address at which the host device desires to write data, a length of data desired to be written, an identifier of the region to which data is to be temporarily stored in the buffer memory array 200, a data storage location in the buffer memory array 200, and a flag indicating the kind of command related to the data.

In the case where the host command is an RPMB write command, the write information may include an RPMB address at which data is to be written in the storage 120.

The first data writer 205 may perform a temporary write process based on the write information generated from the write information generator 203 at step S109. In other words, the write data may be stored to a predetermined location of the buffer memories 210-0 to 210-n allocated by the write information generator 203. If the temporary write operation is completed, the first data writer 205 may transmit, to the host device through the host interface 113, a response signal notifying that the operation of processing the write command has been completed at step S111.

The second data writer 207 may perform a main write process based on the write information generated by the information generator 203 at step S113. In other words, the second data writer 207 may map a start address of a logical block address at which the host device desires to write data to a physical address, and write, starting from a region corresponding to the mapped physical address, write data having a length desired to be written in the storage 120.

If the data temporarily stored in the buffer memory array 200 is stored to the storage 120 in the above-mentioned manner, the second data writer 207 may update the write information according to information indicating the actual length of data written in the storage 120 at step S115, and make a transition to a standby state at step S117. The main write process may be processed at an internally determined point in time, taking into account working conditions of the data storage device 10.

In accordance with various embodiments, a temporarily storage space may be allocated in different ways, depending on the kind of data to be written to a storage medium, whereby user data writing speed may be enhanced.

While various embodiments have been described above, it will be understood to those skilled in the art that the embodiments described are examples only. Accordingly, the data storage device and the operating method thereof described herein should not be limited based on the described embodiments.

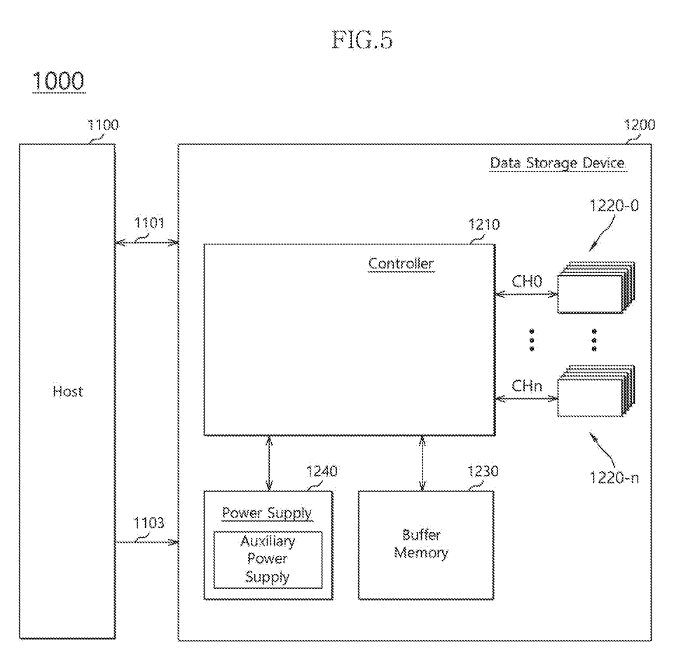

FIG. 5 is a diagram illustrating a data processing system 1000 including a solid state drive (SSD) 1200 in accordance with an embodiment. Referring to FIG. 5, the data processing system 1000 may include a host device 1100 and the SSD 1200.

The SSD 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the SSD 1200. The controller 1210 may include a host interface, a control component, a random access memory used as a working memory, an error correction code (ECC) component, and a memory interface. In an embodiment, the controller 1210 may configured by controller 110 comprising the write control component 20 as shown is FIGS. 1 to 3.

The host device 1100 may exchange a signal with the SSD 1200 through the signal connector 1101. The signal may include a command, an address, data, and the like. The host interface 1211 may interface the host device 1100 and the SSD 1200 according to the protocol of the host device 1100.

The controller 1210 may analyze and process the signal received from the host device 1100. The controller 1210 may control operations of internal function blocks according to firmware or a software for driving the SSD 1200.

The ECC component may detect an error of the data read from at least one of the nonvolatile memory devices 1220-0 to 1220-n. If a detected error is within a correctable range, the ECC component may correct the detected error.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the SSD 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power PWR inputted through the power connector 1103, to the inside of the SSD 1200. The power supply 1240 may include an auxiliary power supply. The auxiliary power supply may supply power to allow the SSD 1200 to be normally completed when a sudden power-off occurs. The auxiliary power supply may include large capacity capacitors.

The signal connector 1101 may be configured by various types of connectors depending on an interface scheme between the host device 1100 and the SSD 1200.

The power connector 1103 may be configured by various types of connectors depending on a power supply scheme of the host device 1100.

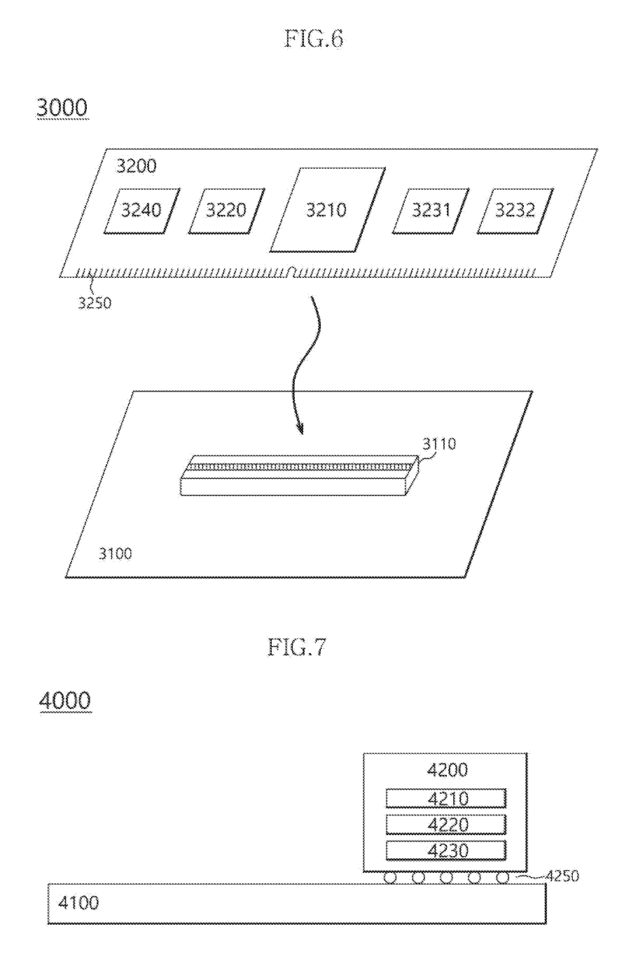

FIG. 6 is a diagram illustrating a data processing system 3000. Referring to FIG. 6, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 comprising the write control component 20 as shown in FIGS. 2 and 3.

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to components in the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and the like and power may be transferred between the host device 3100 and the memory system 3200. The connection terminal 3250 may be configured into various types depending on an interface scheme between the host device 3100 and the memory system 3200. The connection terminal 3250 may be disposed on any side of the memory system 3200.

FIG. 7 is a diagram illustrating a data processing system 4000 including a memory system 4200 in accordance with an embodiment. Referring to FIG. 7, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 comprising the write control component 20 as shown in FIGS. 2 and 3.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

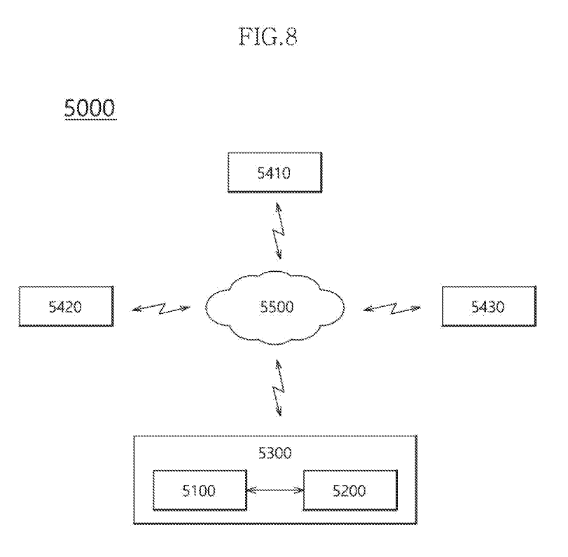

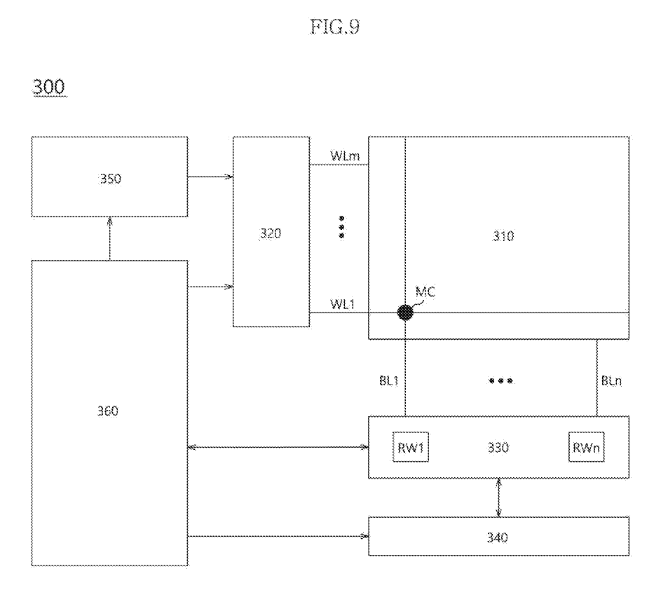

FIG. 8 is a diagram illustrating a network system 5000 including a memory system 5200 in accordance with an embodiment. Referring to FIG. 8, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured by the data storage device 10 shown in FIG. 1, the SSD 1200 shown in FIG. 5, the memory system 3200 shown in FIG. 6, or the memory system 4200 shown in FIG. 7.

FIG. 9 is a block diagram illustrating a nonvolatile memory device 300 in a memory system in accordance with an embodiment. Referring to FIG. 9, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

The memory cell array 310 may comprise a three-dimensional memory array. The three-dimensional memory array has a direction perpendicular to the flat surface of a semiconductor substrate. Moreover, the three-dimensional memory array means a structure including NAND strings which at least memory cell is located in a vertical upper portion of the other memory cell.

The structure of the three-dimensional memory array is not limited thereto. It is apparent that the memory array structure can be selectively applied to a memory array structure formed in a highly integrated manner with horizontal directionality as well as vertical directionality.

While various embodiments have been described above, it will be understood to those skilled in the art that the embodiments described are examples only. Accordingly, the data storage device, the operating method thereof and the storage system including the same described herein should not be limited based on the described embodiments.

What is claimed is:

1. A data storage device comprising:
a storage;
a controller configured to write data to the storage or read data from the storage; and
a plurality of buffer memories,
wherein the controller comprises a write control component configured to allocate a buffer memory, of the plurality of buffer memories, for temporarily storing data to be written in different ways depending on a kind of the data to be written to the storage based on a write-related command received from a host device.

2. The data storage device according to claim 1,
wherein the allocated buffer memory comprises at least one input/output buffer memory and at least one auxiliary buffer memory, and
wherein the e control component is configured such that, when the data to be written is user data, the user data is temporarily stored to the at least one input/output buffer memory, and, when the data to be written is not user data, the data to be written is temporarily stored to the at least one auxiliary buffer memory.

3. The data storage device according to claim 2, wherein the non-user data to be written is replay protected memory block (RPMB) data or dummy data.

4. The data storage device according to claim 1, wherein the write-related command includes a normal write command, a replay protected memory block (RPMB) write command, or a unmap command.

5. The data storage device according to claim 1, wherein the write control component is configured to generate write information including a logical address of the storage to which data is to be written, a length of the data desired to be written, an identifier of the allocated buffer memory, a storage location of the data to be written in the allocated buffer memory, and a kind of the write-related command.

6. The data storage device according to claim 5, wherein the write control component is configured to store the data temporarily stored in the allocated buffer memory to the storage and update the write information according to information indicating a length to which the data is actually written to the storage.

7. A data storage device comprising a storage, a plurality of buffer memories, and a controller configured to control data exchange with respect to the storage,
wherein the controller comprises:
a command parser configured to parse a write-related command received from a host device;
a write information generator configured to allocate a buffer memory, of the plurality of buffer memories, for temporarily storing data to be written in different ways depending on a kind of the data to be written to the storage based on a result of a parsing operation of the command parser, and generate write information needed to write the data;
a first data writer configured to write data to the allocated buffer memory based on the write information; and
a second data writer configured to write the data temporarily stored in the allocated buffer memory to the storage based on the write information.

8. The data storage device according to claim 7, wherein the first data writer is configured to write data to the allocated buffer memory and notify the host device that an operation of processing a write command is completed.

9. The data storage device according to claim 7,
wherein the allocated buffer memory comprises at least one input/output buffer memory and at least one auxiliary buffer memory, and
wherein the write information generator is configured such that, when the data to be written is user data, the user data is temporarily stored to the at least one input/output buffer memory, and, when the data to be written is not user data, the data to be written is temporarily stored to the at least one auxiliary buffer memory.

10. The data storage device according to claim 9, wherein the non-user data to be written is replay protected memory block (RPMB) data or dummy data.

11. The data storage device according to claim 7, wherein the write-related command includes a normal write command, a replay protected memory block (RPMB) write command, or a unmap command.

12. The data storage device according to claim 7, wherein the write control component is configured to generate write information including a logical address of the storage to which data is to be written, a length of the data desired to be written, an identifier of the allocated buffer memory, a storage location of the data to be written in the allocated buffer memory, and a kind of the write-related command.

13. The data storage device according to claim 12, wherein the write information generator is configured such that the second data writer stores the data temporarily stored in the allocated buffer memory to the storage and updates the write information according to information indicating a length to which the data is actually written to the storage.

14. A method of operating a data storage device comprising a storage, a plurality of buffer memories, and a controller configured to control data exchange with respect to the storage, the method comprising:
parsing, by the controller, a write-related command received from a host device;
allocating a buffer memory, of the plurality of buffer memories, for temporarily storing data to be written in different ways depending on a kind of the data to be written to the storage based on a result of the parsing, and generating write information to write the data;
writing data, in a temporary write operation, to the allocated buffer memory based on the write information; and
writing the data temporarily stored in the allocated buffer memory, in a main write operation, to the storage based on the write information.

15. The method according to claim 14, further comprising, after the temporary write operation, notifying the host device that processing a write command is completed.

16. The method according to claim 14,
wherein the buffer memory comprises at least one input/output buffer memory and at least one auxiliary buffer memory, and
wherein the allocating of the buffer memory comprises allocating, when the data to be written is user data, the buffer memory such that the user data is temporarily stored to the at least one input/output buffer memory, and allocating, when the data to be written is not user data, the buffer memory such that the data to be written is temporarily stored to the at least one auxiliary buffer memory.

17. The method according to claim 16, wherein the non-user data to be written is replay protected memory block (RPMB) data or dummy data.

18. The method according to claim 14, wherein the write-related command includes a normal write command, a replay protected memory block (RPMB) write command, or a unmap command.

19. A storage system comprising:
a host device; and
a data storage device including a storage, a plurality of buffer memories, and a controller configured to write data to the storage or read data from the storage,
wherein the controller comprises a write control component configured to allocate a buffer memory, of the plurality of buffer memories, for temporarily storing data to be written in different ways depending on a kind of the data to be written to the storage based on a write-related command received from the host device.

20. The storage system according to claim 19,
wherein the allocated buffer memory comprises at least one input/output buffer memory and at least one auxiliary buffer memory, and
wherein the write control component is configured such that, when the data to be written is a user data, the user data is temporarily stored to the at least one input/output buffer memory, and, when the data to be written is not a user data, the data to be written is temporarily stored to the at least one auxiliary buffer memory.

21. A memory system comprising:
a memory device configured to store data;
first and second buffer memories configured to buffer data to be stored into the memory device; and
a controller configured to:
buffer, in response to a first write command, first data in the first buffer memory; and
buffer, in response to a second write command, second data in the second buffer memory, and generate third data from the second data, the third data being appropriate for storage into the memory device;
transmit a write completion message; and
control the memory device to store the first and third data therein after transmit the write completion message.
